(19) United States
(12) Patent Application Publication
(10) Pub. No.: US 2004/0228347 A1
(43) Pub. Date: Nov. 18, 2004

(54) Enabling active pdp contexts in additional plmns according to home operator information and/or subnetwork information

(76) Inventors: Tuija Hurtta, Espoo (FI); Serge Haumont, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/485,915

(22) PCT Filed: Aug. 9, 2001
(86) PCT No.: PCT/EP01/09230

(51) Int. Cl. H04L 12/56

(52) U.S. Cl. 370/395.2; 370/328

(57) ABSTRACT

A packet data network system according to the present invention comprises a plurality of gating means (GGSN) via which data can be routed to a destination address at an external network (PDN), serving means (SGSN) and an end station (MS) for requesting, from the serving means, the establishment of a connection to a certain access point (APN). The serving means are arranged to select gating means supporting this access point from the plurality of gating means and to establish a connection between the end station and an external network through the selected gating means, wherein the connection request is accepted and the connection is established on the basis of at least one acceptance list.

### FIELD OF THE INVENTION

The present invention relates to routing data in a packet data radio network system from a serving GPRS support node to a target address at an external network via one of a plurality of gateway GPRS support nodes.

### BACKGROUND OF THE INVENTION

In GPRS/UMTS (General Packet Radio Service/Universal Mobile Telecommunications System) systems, advanced roaming mechanisms have been designed. They allow a roamer to get a local access (use Visited GGSN (Gateway GPRS Support Node)) if the accessed network (which is indicated by an APN (Access Point Name) Network Identifier (NI) as explained below) is locally available. If this network is not locally available, the user is then connected to the proper network through its home network. This model assumes that the user can always find the desired access from its home network. It also assumes agreements between operators, in particular to perform charging.

In GPRS/UMTS systems, connections to external Packet Data Networks (PDNs) are established through the PDP context activation procedure. In a PDP (Packet Data Protocol) Context Activation Procedure as shown in FIG. 1, an MS (Mobile Station) sends an Activate PDP Context Request message to an SGSN (Serving GPRS (General Packet Radio Service) Support Node) in a PLMN (Public Land Mobile Network). The MS may use an APN (Access Point Name) to select a reference point to a certain external network. The APN is a logical name referring to the external packet data network that the subscriber wishes to connect to. To support inter-PLMN roaming, the internal GPRS DNS (Domain Name Server) functionality is used to translate the APN into the IP address of the GGSN.

The APN is composed of two parts as follows:

The APN Network Identifier (NI) which defines to which external network the GGSN is connected to and optionally defines a requested service by the MS. This part of the APN is mandatory.

The APN Operator Identifier (OI) which defines in which PLMN GPRS backbone the GGSN is located. This part of the APN is optional.

The APN Operator Identifier (OI) is placed after the APN Network Identifier. An APN consisting of both the Network Identifier and Operator Identifier corresponds to a DNS name of a GGSN. An APN is usually displayed as a string in which the labels are separated by dots (e.g. “Label1.Label2.Label3”).

The APN is further described in 3GPP TS 23.003, and its usage in 3GPP TS 23.060. The MS may include in the Activate PDP Context Request message:

no APN (a default APN is then selected from HLR or SGSN),

only the APN NI (OI is then selected by SGSN and appended to APN NI before DNS query),

or both APN NI and OI.

The SGSN validates the Activate PDP Context Request using the APN and other criteria.

If a GGSN (Gateway GPRS Support Node) address can be derived, the SGSN sends a Create PDP Context Request message to the affected GGSN. The GGSN may use the APN to find an external network. A Selection Mode indicates whether a subscribed APN was selected, or whether a non-subscribed APN sent by the MS or a non-subscribed APN chosen by the SGSN was selected. The GGSN may use the Selection Mode when deciding whether to accept or reject the PDP context activation. For example, if an APN requires subscription, then the GGSN is configured to accept only the PDP context activation that requests a subscribed APN as indicated by the SGSN with Selection Mode. The GGSN creates a new entry in its PDP context table and creates a Charging Id. The new entry allows the GGSN to route PDP PDUs (Packet Data Units) between the SGSN and the external PD network (typically an IP network) and to start charging. The GGSN returns a Create PDP Context Response message to the SGSN. The SGSN returns an Activate PDP Context Accept message to the MS. The SGSN is now able to route PDP PDUs between the GGSN and the MS and to start charging.

A VPLMN (Visited PLMN) Address Allowed information in HLR (Home Location Register) Subscription Data specifies whether the MS is allowed to use the APN in the domain of the HPLMN (Home PLMN) only, or additionally the APN in the domain of the VPLMN. In case VPLMN address is allowed, a PDP context may be activated in the GGSN of the HPLMN or in the GGSN of the VPLMN. Other requests are rejected by the SGSN. Hence, according to the current GPRS, the PDP context activation is restricted to only HPLMN or VPLMN. It should be noted that by including the APN OI in the create PDP context request, the MS can request the GGSN to be located in any PLMN.

A flag HPLMN Allowed may be set in the HLR Subscription Data. This prevents a user to use its Home GGSN when roaming.

The above-described problems prevent the possibility for international service providers offering service from different networks and the use of different networks under the administration of one multinational operator. For example, a large company may have its own APN dedicated to its Intranet access. However, it may not have an agreement to have APN access in every country where it has offices. Therefore, the company would like to get a few agreements in its major country and to have its staff in other countries also benefiting from the Intranet access.

### SUMMARY OF THE PRESENT INVENTION

It is therefore an object of the present invention to improve service provision from a plurality of different networks.

According to the present invention, this object is achieved by a packet data network system comprising:

a plurality of gating means via which data can be routed to a destination address at an external network;

serving means; and

an end station for requesting, from the serving means, the establishment of a connection to a certain access point;

wherein the serving means are arranged to select gating means supporting this access point from the plurality of gating means and to establish a connection between the end station and an external network through the selected gating means, and

wherein the connection request is accepted and the connection is established on the basis of at least one acceptance list.

Furthermore, the object is achieved by a method of establishing a connection in a packet data network system from serving means to an external network via one of a plurality of gating means, the method comprising the steps of:

storing at least one acceptance list;

determining, on the basis of an access point, the one of the plurality of gating means for establishing the connection; and

deciding on the basis of the stored acceptance list whether the connection can be established via the one gating means.

The access point may be indicated by an APN of the GPRS/UMTS system or by any other identifiers (domain names, IP addresses and subnetwork addresses).

According to an embodiment of the present invention, the network system comprises memory means for storing an acceptance list comprising allowed gating means operators for the serving means. The memory means provide the stored acceptance list to the serving means, and the serving means decide whether the connection can be established via the one gating means for external network access on the basis of the stored acceptance list and establish the connection to this gating means in case of allowance.

The memory means may store data All PLMN Allowed in an acceptance list indicating that gating means may be selected in any operators by the serving means and provide these data to the serving means.

The memory means may further store data indicating a default gating means or a default Operator identifier in which the gating means should be selected in case no gating means can be derived from the access point indicated, and provide these data to the serving means.

According to another embodiment, the serving means store an acceptance list comprising an Allowed “VPLMN equivalent” Operator identifier in which the gating means should be selected and decide whether the connection can be established via the one gating means for external network access on the basis of the stored acceptance list and establish the connection to this gating means in case of allowance.

Moreover, also the gating means may store an acceptance list comprising allowed users or subscribers (identified from IMSI, MSISDN, user name or sending addresses) and/or allowed serving means and decide whether the connection requested from the serving means can be established to the external network on the basis of the acceptance list.

According to the present invention, there is also provided a serving network node in a packet data network, the serving network node being arranged to receive a request to establish a connection to an external network from an end station, and to select one of a plurality of gating means and to establish a connection between the end station and an external network through the selected gating means, on the basis of at least one acceptance list.

The acceptance list which may be stored in the serving network node may comprise an allowed “VPLMN equivalent” Operator identifier (in which the gating means should be selected), an “Allowed by Home operator” Operator identifier, or a default entity. The acceptance list may be dependent of the identity of the subscriber operator (Mobile Network Code and Mobile Country Code).

Moreover, according to the present invention, there is provided a gating network node in a packet data network, the gating network node being arranged to receive a connection request including an address of serving means and an identity of the end station and/or subscriber and/or user from the serving means, and to establish the requested connection on the basis of at least one acceptance list comprising allowed serving means and/or allowed identities.

It should be noted that allowed serving means and allowed identities are preferably defined as a range of identities, such as all IP address starting with 1.1.23.*

In addition, according to the present invention, there is provided a memory network node in a packet data network,

said memory network node being arranged to store at least one acceptance list comprising allowed gating means operators for serving means and to provide the acceptance list to the serving means in the network.

The present invention removes the unnecessary restriction to use a GGSN only in the home or in the visited network in both GPRS and UMTS (Universal Mobile Telecommunications System). Moreover, the invention handles the handover between operators, which may lead to a case where the SGSN, the GGSN and the HLR are all in different PLMNs.

While the invention allows GGSN, SGSN and HLR to all belong to different operators, it assumes that this is allowed only if the different operators have proper existing agreements so that the Mobile Station can be charged. These agreements may be one or a combination of the following possibilities:

SGSN operator has agreement with GGSN operators to consider their GGSNs equivalent to VPLMN GGSN. GGSN needs to check from SGSN address that the MS belongs to a partner SGSN operator. This is not seen by the HLR operator, as it makes no difference who operates the GGSN. In this case the SGSN operator charges the HLR operator for the connection, and the GGSN operator charges the SGSN operator. The HLR operator charges the subscriber.

HLR operator has agreement with GGSN operators, so that their GGSNs are “Allowed by Home operator”. To minimize the configuration of the MS, the HLR should also indicate to the SGSN a default APN Operator identifier to be used instead of Home APN operator Identifier (currently derived from IMSI). GGSN needs to check from subscriber identity that the MS belongs to a partner HLR operator. In this case the SGSN operator charges the HLR operator for its part of the connection, and the GGSN operator charges the HLR operator. The HLR operator charges the subscriber.

GGSN operator has direct agreement with the subscriber. GGSN needs to check the subscriber or user identity, for example using MSISDN and/or user name+password. The HLR operator should then allow the connection to All PLMN. In this case the SGSN operator charges the HLR operator for its part of the connection, and the GGSN operator charges the subscriber for its part of the connection.

The HLR operator also charges the subscriber. It should be noted that in all above-mentioned examples the SGSN and HLR operators need a roaming agreement similar to what is currently existing.

In the following the present invention will be described by way of preferred embodiments thereof with reference to the accompanying drawings.

### BRIEF DESCRIPTION OF THE DRAWINGS

FIG. 1 shows a PDP Context Activation Procedure.

FIG. 2 shows a schematic block diagram illustrating a network architecture according to GPRS.

FIG. 3 shows a flowchart of the operation performed during an SGSN Decision on the basis home operator information according to an embodiment of the present invention.

FIG. 4 shows a flowchart of the operation performed during a GGSN Decision on the basis of home operator information according to an embodiment of the present invention.

### DESCRIPTION OF THE PRESENT INVENTION

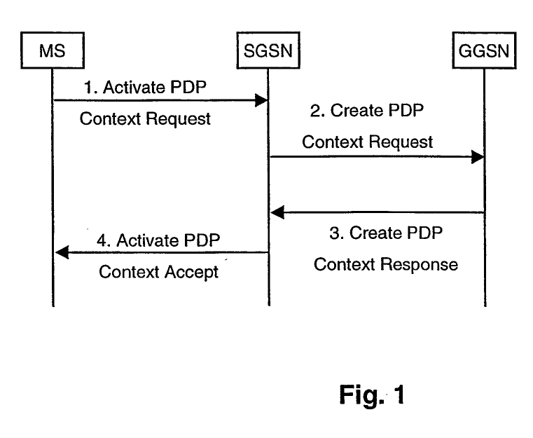

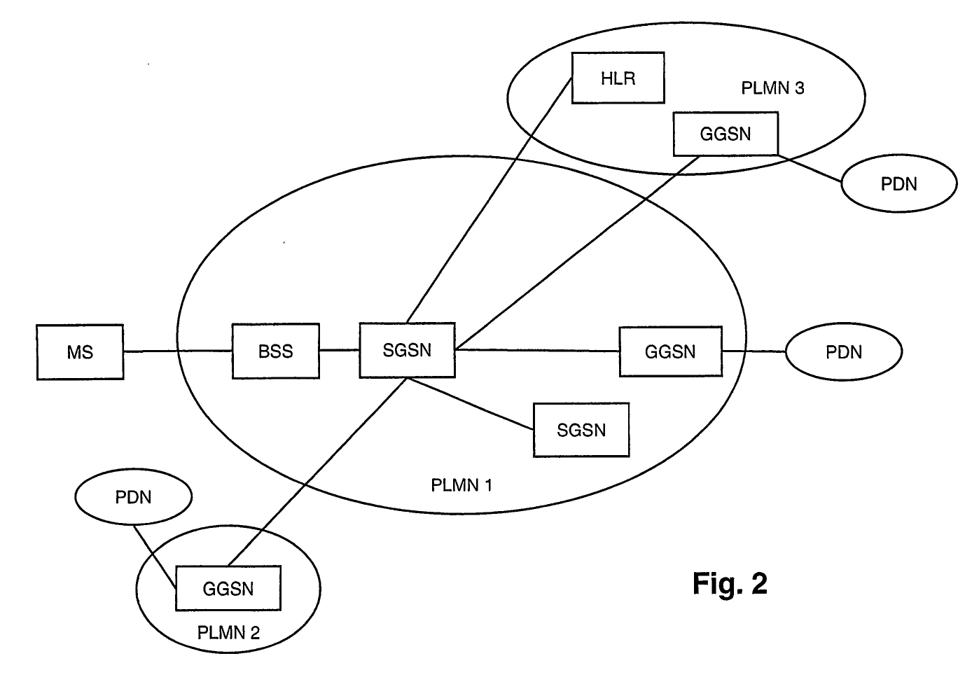

As shown in FIGS. 1 and 2, when an MS sends an Activate PDP Context Request message to an SGSN via a BSS (Base Station System)(or UTRAN (Universal Terrestrial Radio Access Network) in UMTS), the SGSN has to select a GGSN for accessing an external network PDN according to the APN in the context activation message and the HLR subscriber data (flags HPLMN Allowed, VPLMN allowed, and according to this invention All PLMN allowed flag or “Allowed by Home operator” Operator identifier list).

The MS may in addition to the APN NI send any APN OI. The SGSN will first check if VPLMN is allowed by HLR. If it is, SGSN will check if this received 01 corresponds to VPLMN OI or an equivalent to VPLMN OI.

In case of an SGSN handover (sometimes referred to as Inter SGSN Routing Area update), the new SGSN needs to check whether the connection can be maintained with the GGSN selected by the old SGSN. A typical case when the connection cannot be maintained may be that the new SGSN and the old SGSN belong to different operators, and the new SGSN operator does not have the proper agreement with the GGSN operator. After handover, the new SGSN needs to perform a check similar to the one needed to establish a new connection.

The idea of the present invention is to establish connections (i.e. PDP contexts) whenever operators have appropriate agreements. To allow the operator to ensure that new connections are allowed by their agreement (e.g. chargeable), this invention introduces new parameters in a packet data radio network like GPRS or UMTS. One new parameter is an acceptance list which can be added to the HLR subscription data. This acceptance list contains an indication “All PLMN Allowed” or a list of allowed PLMNs using the Operator Identifier part of APN. This parameter is used by an SGSN during GGSN selection process. If All PLMN Allowed is set, there are no restrictions on the GGSN location. Otherwise the GGSN should belong to an operator defined in the HLR list, or the Visited PLMN (or equivalent GGSN) if the use of the VPLMN is allowed in HLR. The HLR subscription data is sent to the SGSN during attach or Routing Area Update procedures.

In the SGSN, there may also be configured a list of IP addresses, subnet addresses and/or allowed APNs which indicate the networks, with which the operator has contracts. Preferably, the SGSN uses the APN OI to check if the connection to a given GGSN is allowed during PDP context activation, and IP address or subnet if the connection to a given GGSN can be maintained after handover. Similarly, in the GGSN there may be a configured list of allowed SGSNs which may request context activation. For instance, in an AOL GGSN in Sweden there may be specified that only Sonera SGSNs in Finland and Estonia may use the AOL GGSN in Sweden.

In the HLR, a default APN operator identifier may be specified. This is used if the MS does not specify the operator identifier part of the APN. The SGSN uses this default APN OI instead of the Home APN OI (normally derived from IMSI) in order to derive a valid GGSN. The SGSN may still first try to derive the APN NI in the VPLMN if allowed.

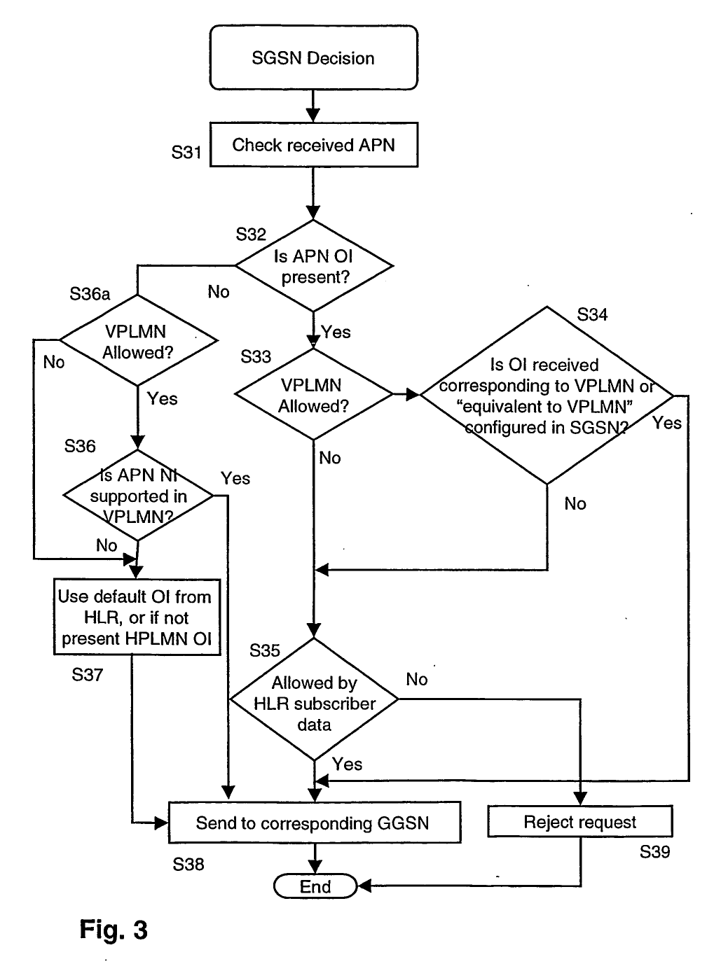

With respect to FIG. 3, an SGSN decision on the basis of the information received from the MS, the home operator information and the SGSN configured information according to an embodiment of the present invention will be described.

In the following description, it is assumed that the MS sends an APN in the request. If no APN is included the normal behavior can be found from 3GPP TS23.060. An improvement that this invention brings to this known behavior is that a default Operator Identifier received from HLR subscriber data may be used instead of Home OI derived from IMSI.

When receiving an APN at PDP context activation or SGSN handover, in checking the received APN (S31), the SGSN checks whether this APN contains an OI part (S32).

If Yes, the SGSN first checks whether VPLMN is allowed (S33), and if Yes, the SGSN checks (S34) whether the OI corresponds to the VPLMN or an equivalent to VPLMN OI (if SGSN has a list of OI equivalent to VPLMN configured as proposed in this invention). If the check result is positive, the request is accepted (S38). If the answer is negative check S35 is performed.

If VPLMN is not allowed, the SGSN checks (S35) whether the requested OI is allowed by HPLMN (from HLR subscriber data). If HLR subscriber data contains a flag “All PLMN allowed”, the request is accepted (S38). If HLR subscriber data contains the requested OI in the list of “Allowed by Home operator” Operator identifier, the request is accepted (S38). If the requested OI is the HPLMN OI and HLR allows the use of home GGSN (flag HPLMN Allowed), the request is accepted (S38). Otherwise, the PDP context request is rejected (S39).

If no OI was sent by the MS, the SGSN will first try to find the APN NI in the VPLMN if allowed by HLR data (S36a, S36)). If the DNS cannot resolve the APN with VPLMN, or use of VPLMN GGSN is not allowed, the SGSN tries to resolve the APN by appending the default APN OI from the HLR subscriber data, or, if not present, the HPLMN OI derived from IMSI.

It should be noted that accepting the request means to try to resolve the full APN (NI and OI) from the DNS. This APN is expected to be resolvable as long as the MS requested a valid APN. Of course if the DNS is not able to resolve the APN (e.g. syntax error), the PDP context will be rejected as no GGSN can be selected.

It should also be noted that the invention is not related to the exact order of checks but to the use of one or more of the following ideas:

A list of allowed OIs is stored in the HLR subscription data and is sent from the HLR to the SGSN. The list specifies which OI may be accepted as part of the Operator Identifier of the APNs. This information is specific to the home operator. From the HLR to a specific SGSN, the list may be sent only once. If the list has been modified, it is sent again to the specific SGSN. This OI list may contain the undefined part “*”, for example “telia.*.gprs” (indicating that any telia network in whatever country is acceptable). Similarly the coding of All PLMN Allowed could be *.*.gprs. Alternatively, the list may be exchanged as part of a roaming agreement.

A list of equivalent to VPLMN OI is stored in the SGSN. The list specifies which OI may be accepted if VPLMN use is allowed as part of the Operator Identifier of the APNs. This information is specific to the visited operator. As previously explained, this list may contain the undefined part “*”.

In case the Operator Identifier in the APN is not specified by the MS, a Default APN Operator Identifier set in the HLR subscription data can be used together with the already existing Access Point Name NI in the HLR, or with the APN NI requested by the MS in order to define the complete APN to be used to query the DNS.

In case of handover, the new SGSN may check the APN OI received from the old SGSN in the PDP context information. This OI is used according to FIG. 3 starting from step 33. The result will be maintaining the PDP context instead of sending it to the corresponding GGSN (S38), or deleting the PDP context instead of rejecting the request (S39).

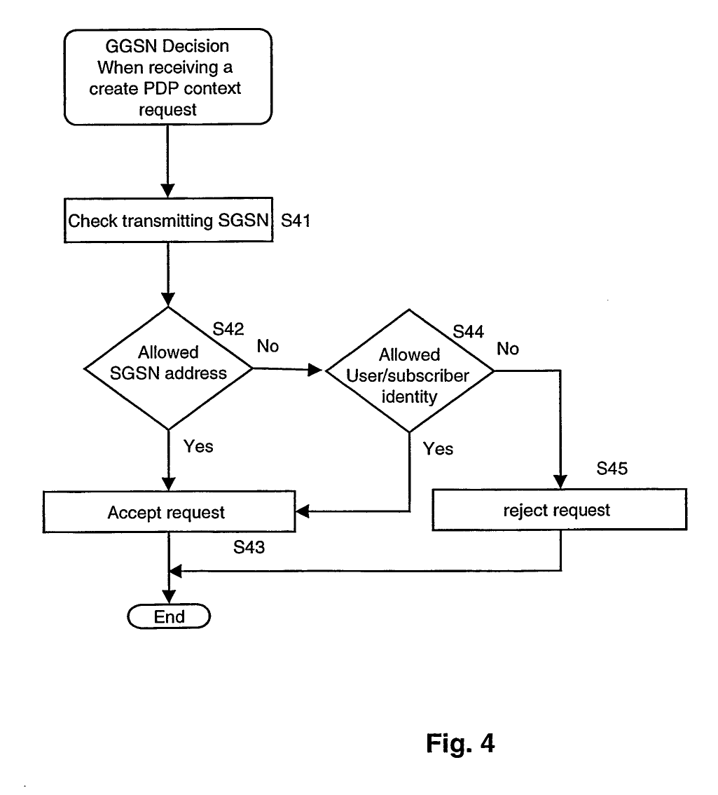

According to another embodiment of the present invention, the GGSNs may be enabled to make the decision, from which SGSNs or user/subscriber they accept context activation. FIG. 4 shows operation steps for a GGSN decision to accept or reject a create PDP context request. In this case, a list of SGSN IP addresses (or preferably subnets) and/or subscriber user identities that the GGSN operator accepts has to be accessible by the GGSN and may be valid on a per GGSN or a per APN basis. The list preferably specifies one or more of the following things:

which MCCs (Mobile Country Codes) or MCC and MNC (Mobile Network Code) pairs may be accepted as part of the IMSIs (International Mobile Subscriber Identities). This indicates the Home operator with which the GGSN operator has an agreement. If no list is used, all MCC/MNC are acceptable;

which SGSN IP address or subnet may be accepted as part of an SGSN address. A subnet is preferably used as it represents less configuration, as all SGSNs from one operator may be located in same subnet (and one SGSN typically has many addresses). The GGSN can check the Home operator from the MNC/MCC in the subscriber IMSI and the Visited operator from the SGSN address/subnet. If no list is used, all SGSNs are acceptable;

which user or subscriber identity may be accepted. Subscriber identity is typically IMSI or MSISDN (already authenticated by SGSN). User identity is typically a user name validated by a password. If no list is used, all users or subscribers are acceptable.

If one of these entities is not used by the GGSN, the corresponding check is not implemented.

As shown in FIG. 4, when the GGSN receives a Create PDP Context Request message it checks the transmitting SGSN in step S41. In case the SGSN is present in an allowed subnet or use allowed address in step S42, the GGSN accepts the create PDP context sent from the SGSN in step S43. Otherwise, the GGSN checks the subscriber identity in S44. If the MS uses an allowed MNC/MCC, or if the user/subscriber identity is allowed, the GGSN accepts the SGSN request (S43). Otherwise, the SGSN request is disregarded (S45).

The GGSN decision can be combined with the SGSN decision according to FIG. 3 such that after step S36 in FIG. 3 a further check is made by the GGSN according to FIG. 4. It should be noted that GGSN checks are especially useful if some HLR operators use the all PLMN allowed option.

Another implementation consists in having the decision to accept the PDP context made in an external server instead of the GGSN, such as a RADIUS server. In this case the RADIUS server needs to have access to the configured information as described above and implement the same logic. Current Radius servers are typically queried when a create PDP context request is received to allocate an IP address and/or to check a password.

According to a further embodiment of the present invention, in order to allow PDP context activation in additional PLMNs, an operator specific list of allowed domain names or IP addresses is configured to the SGSN. The list specifies which domain names may be accepted as part of the Operator Identifier of the APNs or which IP addresses may be accepted as part of the GGSN addresses. This list may contain the undefined part “*”, for example, “telia.*.gprs”.

As can be understood from the foregoing, the present invention removes the unnecessary restriction to use a GGSN only in the home or visited network in both GPRS and UMTS. Handovers between operators can be handled, and, thus, the case can be handled in which the SGSN, GGSN and HLR are located in different PLMNs.

While the invention has been described using a list of allowed APN OIs, the check to know where is an end station could similarly been built on a list of forbidden APN OIs, or other identifiers.

While the invention has been described with reference to preferred embodiments thereof, the description is illustrative of the invention and is not to be construed as limiting the invention. Various modifications and applications may occur to those skilled in the art without departing from the true spirit and scope of the invention as defined by the appended claims.

1-17. (Cancelled)

18. A packet data network system comprising:
a plurality of gating means (GGSN) via which data can be routed to a destination address at an external network (PDN), said plurality of gateways being located in a plurality of packet data networks including a home network and a visited network;
serving means (SGSN); and
an end station (MS) for requesting, from the serving means, the establishment of a connection to a certain access point (APN);
wherein the serving means are arranged to select gating means supporting this access point from the plurality of gating means and to establish a connection between the end station and an external network through the selected gating means, and
wherein the connection request is accepted and the connection is established on the basis of at least one of a plurality of acceptance lists, comprising an indication whether gating means of the visited network are allowed to be selected.

19. A system according to claim 18, further comprising memory means (HLR) for storing the at least one acceptance list comprising allowed gating means operators for the serving means.

20. A system according to claim 18, wherein the access point is indicated by an Access Point Name of a GPRS/UMTS system.

21. A system according to claim 18, wherein the access point is indicated by at least one of a domain name, IP address and subnetwork address.

22. A system according to claim 18, wherein the serving means are arranged to store another one of the plurality of acceptance lists, comprising an allowed VPLMN equivalent Operator identifier in which the gating means are to be selected.

23. A system according to claim 18, wherein the serving means are arranged to store another one of the plurality of acceptance lists, comprising an allowed by Home operator Operator identifier.

24. A system according to claim 18, wherein the serving means are arranged to store another one of the plurality of acceptance lists, comprising a default entity.

25. A system according to claim 22, wherein the serving means are arranged to decide whether the connection can be established via the one gating means for external network access on the basis of the stored acceptance list and establish the connection to this gating means in case of allowance.

26. A system according to claim 18, wherein the gating means are arranged to store another one of the plurality of acceptance lists, comprising allowed users or subscribers and/or allowed serving means and decide whether the connection can be established to the external network on the basis of the stored acceptance list.

27. A system according to claim 19, wherein the memory means are arranged to provide the stored acceptance list to the serving means, and the serving means are arranged to decide whether the connection can be established via the one gating means for external network access on the basis of the stored acceptance list and establish the connection to this gating means in case of allowance.

28. A system according to claim 19, wherein the memory means are arranged to store data All PLMN Allowed in the acceptance list indicating that gating means may be selected in any operators by the serving means and provide these data to the serving means.

29. A system according to claim 28, wherein the memory means are further arranged to store data indicating a default gating means or a default Operator identifier in which the gating means is to be selected in case no gating means can be derived from the indicated access point, and provide these data to the serving means.

30. A system according to claim 18, wherein the acceptance list is dependent on the identity of the subscriber operator.

31. A serving network node (SGSN) in a packet data network,
said serving network node being arranged to receive a request to establish a connection to an external network (PDN) from an end station (MS), and to select one of a plurality of gating means being located in a plurality of packet data networks including a home network and a visited network and to establish a connection between the end station and an external network through the selected gating means, on the basis of at least one of a plurality of acceptance lists, comprising an indication whether gating means of the visited network are allowed to be selected.

32. A gating network node (GGSN) in a packet data network,
said gating network node being arranged to receive a connection request including an address of serving means (SGSN) and an identity of an end station and/or subscriber and/or user from the serving means and to establish the requested connection on the basis of at least one acceptance list comprising allowed serving means and/or allowed identities.

33. A memory network node (HLR) in a home packet data network,
said memory network node being arranged to store at least one acceptance list comprising an indication whether gating means of a visited network are allowed to be selected and comprising allowed gating means operators for serving means in a visited packet data network and to provide the acceptance list to the serving means (SGSN).

34. A method of establishing a connection in a packet data network system from serving means (SGSN) to an external network (PDN) via one of a plurality of gating means (GGSN) being located in a plurality of packet data networks including a home network and a visited network, the method comprising the steps of:
storing at least one acceptance list comprising an indication whether gating means of a visited network are allowed to be selected;
determining, on the basis of an access point, the one of the plurality of gating means for establishing the connection; and
deciding on the basis of the stored acceptance list whether the connection can be established via the one of the plurality of gating means.
